(19) United States
(12) Patent Application Publication
(10) Pub. No.: US 2020/0290340 A1
(43) Pub. Date: Sep. 17, 2020

(54) ENDLESS FLEXIBLE BELT FOR A PRINTING SYSTEM

(71) Applicant: LANDA CORPORATION LTD., Rehovot (IL)

(72) Inventors: Helena CHECHIK, Rehovot (IL); Shoham LIVADERU, Moshav Sitriyya (IL)

(21) Appl. No.: 16/649,177

(22) PCT Filed: Oct. 16, 2018
(86) PCT No.: PCT/IB2018/058009

§ 371 Date: Mar. 20, 2020

Related U.S. Application Data
(60) Provisional application No. 62/574,275, filed on Oct. 19, 2017.

(51) Int. Cl. B41J 2/01; B41J 11/00; B41J 29/38

(52) U.S. Cl. CPC B41J 2/01; B41J 11/007; B41J 2002/012; B41J 11/0055; B41J 29/38

(57) ABSTRACT

An intermediate transfer member (ITM) for use in a printing system. The ITM includes an endless flexible belt formed of an elongate belt having a longitudinal axis. Attached to lateral edges of the endless flexible belt along the longitudinal axis are a first elongate strip and a second elongate strip, each of the elongate strips including lateral formations on outward facing lateral ends thereof which are distal to the lateral edges of the belt. At least one of the first and second elongate strips includes a first longitudinal portion having a first elasticity, and a second longitudinal portion having a second elasticity, such that the second elasticity is greater than the first elasticity. The first portion is attached to the lateral edges of the flexible belt and the second portion extends between the first portion and the lateral formations.

### FIELD AND BACKGROUND OF THE INVENTION

The present invention relates to an endless flexible belt for a printing system, and more specifically to an endless flexible belt including lateral formations which ensure the proper alignment and registration of the belt during printing. The endless belt of the invention finds particular application as an intermediate transfer member (ITM) in a printing system in which, instead of ink being applied directly onto a substrate, the desired image is formed by ink deposition (e.g. ink jetted droplets) on the intermediate transfer member, the latter then serving to transport the image to an impression station at which the image is impressed on a substrate.

Flexible belts for use as an ITM in a printing system are disclosed in Applicant's U.S. Pat. Nos. 9,290,016, 9,643,403 and 9,517,618.

### SUMMARY OF THE INVENTION

Embodiments of the present invention relate to the construction and installation of a continuous flexible belt, suitable for use as an intermediate transfer member in a printing system, which belt is guided when in use, for instance over rollers.

In accordance with an embodiment of the present invention, there is provided an intermediate transfer member (ITM) for use in a printing system to transport ink images from an image forming station to an impression station for transfer of the ink image from the ITM onto a printing substrate, wherein the ITM includes:

an endless flexible belt having a uniform belt width, the endless flexible belt formed of an elongate belt having a longitudinal axis;

a first elongate strip and a second elongate strip, the first and second elongate strips attached to lateral edges of the belt along the longitudinal axis, the first and second elongate strips each including lateral formations on outward facing lateral ends thereof, the outward facing lateral ends being distal to the lateral edges of the belt,

wherein, during use, the belt is configured to be guided by a guiding system through at least the image forming station, the guiding system including guide channels configured to receive the lateral formations,

wherein at least one of the first and second elongate strips has a strip width and includes a first longitudinal portion extending along the longitudinal axis and having first portion width and a first elasticity, and a second longitudinal portion extending along the longitudinal axis and having a second portion width and a second elasticity, the first portion being attached to the lateral edges of the belt and the second portion extending between the first portion and the lateral formations,

wherein the second elasticity is greater than the first elasticity.

In some embodiments, the lateral formations are configured to engage the guide channels, so that the belt is placed under tension in a width-ways direction perpendicular to the longitudinal axis, and is constrained to follow a continuous path defined by the guide channels.

In some embodiments, the second portion is elastic in a width-ways direction perpendicular to the longitudinal axis.

In some embodiments, the first portion width is in the range of 30% to 90% of the strip width. In some embodiments, a ratio between the first portion width and the strip width is in the range of 1:1.1 to 1:3. In some embodiments, the first portion width is in the range of 15 mm to 30 mm. In some embodiments, the first portion width is in the range of 15 mm to 20 mm

In some embodiments, the second portion width is in the range of 10% to 90% of the strip width. In some embodiments, a ratio between the second portion width and the strip width is in the range of 1:1.1 to 1:10. In some embodiments, the second portion width is in the range of 2 mm to 15 mm. In some embodiments, the second portion width is in the range of 3 mm to 7 mm

In some embodiments, a ratio between the second portion width and the first portion width is in the range of 1:1 to 1:15.

In some embodiments, a ratio between the strip width and the belt width is in the range of 1:25 to 1:47.

In some embodiments, a ratio between the first portion width and the belt width is in the range of 1:33.3 to 1:93.3. In some embodiments, a ratio between the second portion width and the belt width is in the range of 1:66.6 to 1:700.

In some embodiments, the strip width is in the range of 20 mm to 40 mm. In some embodiments, the belt width is in the range of 1000 mm to 1400 mm

In some embodiments, the spring constant of the first portion, or the first elasticity, is at least 10.0, at least 20.0, at least 30.0, at least 40.0 at least 50.0 N/mm, at least 75.0, at least 100.0, at least 125.0, at least 150.0, at least 175.0, or at least 200.0 N/mm, when measured on a sample having a length of 10 mm and a width of 22 mm in the elastic direction. In some embodiments, the first elasticity is at most 5% elongation, at most 4% elongation, at most 3% elongation, at most 2% elongation, at most 1% elongation, at most 0.5% elongation, at most 0.2% elongation, or at most 0.1% elongation.

In some embodiments, the spring constant of the second portion, or the second elasticity is in the range of 0.1 to 10.0 N/mm, 0.1 to 8.0 N/mm, or 0.1 to 5.0 N/mm, 1.0 to 5.0 N/mm, 2.0 to 5.0 N/mm, or 3.0 to 5.0 N/mm, when measured on a sample having a length of 10 mm and a width of 22 mm in the elastic direction. In some embodiments, the second elasticity is at least 5% elongation, at least 8% elongation, or at least 10% elongation, at least 20% elongation, at least 30% elongation, at least 40% elongation, or at least 50% elongation.

In some embodiments, a ratio between spring constant measurements of the second elasticity and the first elasticity, when measured in N/mm on a sample having a sample width of 22 mm and a sample length of 10 mm, is at least 1:4, at least 1:6, at least 1:10, at least 1:12, at least 1:20, at least 1:30, at least 1:40, at least 1:50, at least 1:60, at least 1:70, at least 1:80, at least 1:90, or at least 1:100. In some embodiments, the spring constant ratio is in the range of 1:6 to 1:25.

In some embodiments, the first longitudinal portion is non-elastic, and the second longitudinal portion is elastic. In some embodiments, the first longitudinal portion is somewhat elastic, and the second longitudinal portion is more elastic.

In some embodiments, only the first elongate strip includes the first non-elastic portion and the second elastic portion, and wherein the second elongate strip is non-elastic.

In some embodiments, only the first elongate strip includes the first non-elastic portion and the second elastic portion, and wherein the second elongate strip is elastic.

In some embodiments, the first elongate strip and the second elongate strip each include a the first portion and a the second portion.

In some embodiments, an elasticity of the second portion of the first elongate strip is sufficient to maintain the belt taut when the lateral formations are guided through their respective guide channels.

In some embodiments, the lateral formations include longitudinally spaced formations disposed on each of the outward facing lateral ends of the first and second elongate strips. In some embodiments, at least one of the first and the second elongate strips includes one half of a zip fastener, and wherein the longitudinally spaced formations include teeth of the one half of the zip fastener. In some embodiments, the first elongate strip and the second elongate strip include two complementary portions of a single zip fastener.

In some embodiments, the lateral formations include a continuous flexible bead disposed on each of the outward facing lateral ends of the first and second elongate strips.

In some embodiments, a maximal load applied to the at least one of the first and second elongate strips at a time of failure between the at least one of the first and second elongate strips and the belt is at least 50.0 N/mm

In some embodiments, the belt comprises a support and a release layer, the support layer is made of a fabric that is fiber-reinforced at least in the longitudinal direction of the belt, the fiber being a high performance fiber selected from the group comprising aramid, carbon, ceramic, and glass fibers. In some embodiments, the release layer has a hydrophobic outer surface. In some embodiments, the belt additionally comprises a compressible layer.

In some embodiments, the endless flexible belt is formed from a flat elongate strip, ends of which are configured to be secured to one another at a seam to form a continuous loop. In some embodiments, the belt includes one or more markings detectable by a sensor of the printing system.

In accordance with an embodiment of the present invention, there is provided a method of forming a flexible belt, the method including:

a. obtaining an elongate flexible belt having a uniform belt width and a longitudinal axis, the belt being suitable for use as an ITM in a printing system, the elongate flexible belt having first and second lateral edges;
b. obtaining a first elongate strip having a strip width and including:
a first longitudinal portion extending along the longitudinal axis and having a first portion width and a first elasticity, the first longitudinal portion extending along the first elongate strip at a first lateral end thereof;
lateral formations on a second lateral end of the first elongate strip; and
a second longitudinal portion extending along the longitudinal axis and having a second portion width and a second elasticity, the second longitudinal portion extending longitudinally between the first portion and the lateral formations,
wherein the second elasticity is greater than the first elasticity; and
   c. obtaining a second elongate strip having first and second lateral ends, and including lateral formations on the second lateral end thereof.

In some embodiments, the method further includes attaching the second lateral ends of the first and second elongate strips to the first and second lateral edges of the elongate flexible belt.

In accordance with an embodiment of the present invention, there is provided a printing system including:

a. an intermediate transfer member (ITM) including:
(i) an endless flexible belt having a uniform belt width, the endless flexible belt formed of an elongate belt having a longitudinal axis;
(ii) a first elongate strip and a second elongate strip, each attached to lateral edges of the belt along the longitudinal axis, the first and second elongate strips each including lateral formations on outward facing lateral ends thereof, the outward facing lateral ends being distal to the lateral edges of the belt,
   wherein at least one of the first and second elongate strips has a strip width and includes a first longitudinal portion having a first portion width and a first elasticity, and a second longitudinal portion having a second portion width and a second elasticity, the first portion being attached to the lateral edges of the belt and the second portion extending between the first portion and the lateral formations,
   wherein the second elasticity is greater than the first elasticity;
      b. an image forming station at which droplets of ink are applied to an outer surface of the ITM to form ink images thereon;
      c. an impression station for transfer of the ink images from the ITM onto a printing substrate; and
      d. a guiding system including guide channels configured to receive the lateral formations, the guiding system extending at least through the image forming station and configured, during use, to guide the ITM along the image forming station.

In some embodiments, the guiding system is further configured to guide the ITM through the impression station. In some embodiments, the guide channels further include rolling bearings, and wherein the lateral formations of the ITM are retained within the guide channels by the rolling bearings.

In some embodiments, the engagement between the lateral formations and the guide channels places the belt under tension in a width-ways direction perpendicular to the longitudinal axis, such that the belt is constrained to follow a continuous path defined by the guide channels.

In some embodiments, the second portion is elastic in a width-ways direction perpendicular to the longitudinal axis.

In some embodiments, the first portion width is in the range of 30% to 90% of the strip width. In some embodiments, a ratio between the first portion width and the strip width is in the range of 1:1.1 to 1:3. In some embodiments, the first portion width is in the range of 15 mm to 30 mm. In some embodiments, the first portion width is in the range of 15 mm to 20 mm

In some embodiments, the second portion width is in the range of 10% to 90% of the strip width. In some embodiments, a ratio between the second portion width and the strip width is in the range of 1:1.1 to 1:10. In some embodiments, the second portion width is in the range of 2 mm to 15 mm. In some embodiments, the second portion width is in the range of 3 mm to 7 mm

In some embodiments, a ratio between the second portion width and the first portion width is in the range of 1:1 to 1:15.

In some embodiments, a ratio between the strip width and the belt width is in the range of 1:25 to 1:47.

In some embodiments, a ratio between the first portion width and the belt width is in the range of 1:33.3 to 1:93.3. In some embodiments, a ratio between the second portion width and the belt width is in the range of 1:66.6 to 1:700.

In some embodiments, the strip width is in the range of 20 mm to 40 mm. In some embodiments, the belt width is in the range of 1000 mm to 1400 mm.

In some embodiments, the spring constant of the first portion, or the first elasticity, is at least 10.0, at least 20.0, at least 30.0, at least 40.0 at least 50.0 N/mm, at least 75.0, at least 100.0, at least 125.0, at least 150.0, at least 175.0, or at least 200.0 N/mm, when measured on a sample having a length of 10 mm and a width of 22 mm in the elastic direction. In some embodiments, the first elasticity is at most 5% elongation, at most 4% elongation, at most 3% elongation, at most 2% elongation, at most 1% elongation, at most 0.5% elongation, at most 0.2% elongation, or at most 0.1% elongation.

In some embodiments, the spring constant of the second portion, or the second elasticity is in the range of 0.1 to 10.0 N/mm, 0.1 to 8.0 N/mm, or 0.1 to 5.0 N/mm, 1.0 to 5.0 N/mm, 2.0 to 5.0 N/mm, or 3.0 to 5.0 N/mm, when measured on a sample having a length of 10 mm and a width of 22 mm in the elastic direction. In some embodiments, the second elasticity is at least 5% elongation, at least 8% elongation, or at least 10% elongation, at least 20% elongation, at least 30% elongation, at least 40% elongation, or at least 50% elongation.

In some embodiments, a ratio between spring constant measurements of the second elasticity and the first elasticity, when measured in N/mm on a sample having a sample width of 22 mm and a sample length of 10 mm, is at least 1:4, at least 1:6, at least 1:10, at least 1:12, at least 1:20, at least 1:30, at least 1:40, at least 1:50, at least 1:60, at least 1:70, at least 1:80, at least 1:90, or at least 1:100. In some embodiments, the spring constant ratio is in the range of 1:6 to 1:25.

In some embodiments, the first longitudinal portion is non-elastic, and the second longitudinal portion is elastic.

In some embodiments, only the first elongate strip includes the first non-elastic portion and the second elastic portion, and wherein the second elongate strip is non-elastic.

In some embodiments, only the first elongate strip includes the first non-elastic portion and the second elastic portion, and wherein the second elongate strip is elastic.

In some embodiments, the first elongate strip and the second elongate strip each include the first portion and the second portion.

In some embodiments, an elasticity of the second portion of the first elongate strip is sufficient to maintain the belt taut when the lateral formations are guided through the guide channels.

In some embodiments, the lateral formations include longitudinally spaced formations disposed on each of the outward facing lateral ends of the first and second elongate strips. In some embodiments, at least one of the first and the second elongate strips includes one half of a zip fastener, and wherein the longitudinally spaced formations include teeth of the one half of the zip fastener. In some embodiments, the first elongate strip and the second elongate strip include two complementary portions of a single zip fastener.

In some embodiments, the lateral formations include a continuous flexible bead disposed on each of the outward facing lateral ends of the first and second elongate strips.

In some embodiments, a maximal load applied to the at least one of the first and second elongate strips at a time of failure between the at least one of the first and second elongate strips and the belt is at least 50.0 N/mm

In some embodiments, the belt includes a support and a release layer, and the support layer is made of a fabric that is fiber-reinforced at least in the longitudinal direction of the belt, the fiber being a high performance fiber selected from the group comprising aramid, carbon, ceramic, and glass fibers.

In some embodiments, the release layer has a hydrophobic outer surface.

In some embodiments, the belt additionally includes a compressible layer.

In some embodiments, the endless flexible belt is formed from a flat elongate strip, ends of which are configured to be secured to one another at a seam to form a continuous loop.

In some embodiments, the belt includes one or more markings detectable by a sensor of the printing system.

In accordance with an embodiment of the present invention, there is provided an elongate strip including:

a first non-elastic portion extending along the first elongate strip at a first lateral end thereof;

lateral formations on a second lateral end of the first elongate strip; and

a second, elastic portion, extending and between the first non-elastic portion and the lateral formations.

In accordance with an embodiment of the present invention, there is provided a method of forming the elongate strip described herein, the method including:

weaving an elongate flexible strip;

impregnating a first portion of the elongate flexible strip with at least one of silicone and liquid rubber, so as to form the first, non-elastic portion; and

forming the lateral formations on a lateral edge of the elongate flexible strip distal to the first portion, thereby to form the elongate strip.

In accordance with an embodiment of the present invention, there is provided a method of forming the elongate strip described herein, the method including:

weaving an elongate flexible strip;

laminating a stiff film onto a first portion of the elongate flexible strip so as to form the first, non-elastic portion; and

forming the lateral formations on a lateral edge of the elongate flexible strip distal to the first portion, thereby to form the elongate strip.

In accordance with an embodiment of the present invention, there is provided a method of forming the elongate strip described herein, the method including:

weaving an elongate strip wherein longitudinal threads of the weave include non-elastic threads, and wherein transverse threads of the weave include elastic threads having a first portion coated with a non-elastic coating, wherein an area woven with the first portion of the transverse threads is the first non-elastic portion of the elongate strip;

thermally fixing the elongate strip; and

forming the lateral formations on a lateral edge of the elongate flexible strip distal to the first portion, thereby to form the elongate strip.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 is a schematic representation of one example of a printing system of the invention;

FIGS. 2A, 2B, and 2C are schematic plan view illustrations of three embodiments of a portion of an ITM suitable for use in the system of FIG. 1, according to embodiments of the teachings herein;

FIG. 3 is a plan view of a portion of an elongate strip forming part of each of the ITMs of FIGS. 2A to 2C, the elongate strip including lateral formations for guiding the ITM, the elongate strip including first and second longitudinal portions according to an embodiment of the teachings herein;

FIG. 4 is a section through a guide channel for the ITM within which the lateral formations shown in FIG. 3 are received; and

FIGS. 5A and 5B are schematic illustrations of corresponding elongate strips for both sides of the ITM, such as first and second elongate strips 106 and 108 of FIG. 2A at the time of manufacturing and when attached to a flexible belt, such as belt 102 of FIG. 2A, respectively.

### DESCRIPTION OF SOME EMBODIMENTS OF THE INVENTION

The invention, in some embodiments, relates to an endless flexible belt which may form an endless belt to be used as an ITM suitable for use with indirect printing systems.

The invention, in some embodiments, relates to an elongate strip connectable to the endless flexible belt or forming part thereof, which strip includes along an elongate lateral end thereof lateral formations which may be used to guide the endless flexible belt in a printing system, as well as two longitudinal portions each having a different elasticity, such that a portion of the strip connected to the endless flexible belt is less elastic than a portion of the strip distal to the endless flexible belt and connected to the lateral formations. The invention, in some embodiments, relates to a method for forming an ITM from a flexible belt and the elongate strip of the invention.

The present invention is intended to solve problems arising when using prior art methods of guiding the flexible elongate belt through the printing system.

In some existing printing systems, an elastic elongate strip having lateral formations thereon is attached to each of the lateral edges of a flexible belt, and the lateral formations are guided through guiding tracks of the printing system, thereby to form an ITM. However, when force is applied to the elastic strip, for example due to changes in the distance between the guiding tracks, the entirety of the elastic strip stretches, and because the elastic strip is connected directly to the flexible belt, this causes pulling or warping of the flexible belt as well. Additionally, force applied to the elastic strip causes pulling or stretching of the elastic strip also at the section thereof which is connected to the flexible belt, which may result in failure of the connection between the flexible belt and the elastic strip.

The present invention solves the deficiencies of existing belts by creating in the elongate strip including the lateral formations two longitudinal portions. One of these portions, which is less elastic, and in some cases is non-elastic, is attached to the flexible belt, and the other portion, which is more elastic, is adjacent the lateral formations. As such, the elongation of the more elastic portion has less impact on, and in some embodiments is completely separate from and has no impact on, the flexible belt, resulting in reduced warping of the flexible belt and in reduced failure of the connection between the flexible belt and the elongate strip, as explained in further detail hereinbelow.

The principles, uses and implementations of the teachings herein may be better understood with reference to the accompanying description and figures. Upon perusal of the description and figures present herein, one skilled in the art is able to implement the invention without undue effort or experimentation. In the figures, like reference numerals refer to like parts throughout.

Before explaining at least one embodiment in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purposes and should not be regarded as limiting.

Additional objects, features and advantages of the invention will be set forth in the detailed description which follows, and in part will be readily apparent to those skilled in the art from the description or recognized by practicing the invention as described in the written description and claims hereof, as well as the appended drawings. Various features and sub-combinations of embodiments of the invention may be employed without reference to other features and sub-combinations.

It is to be understood that both the foregoing general description and the following detailed description, including the materials, methods and examples, are merely exemplary of the invention, and are intended to provide an overview or framework to understanding the nature and character of the invention as it is claimed, and are not intended to be necessarily limiting.

As known in the art, the elasticity of a material can be approximated as a spring constant k. In the linear-elastic range of a material, k is the factor characteristic of the elastic body setting the relation between the force F needed to extend the material and the distance X of extension resulting from such force. This can be mathematically represented by F=k*X, the force F being typically expressed in newtons (N or kg·m/s2), the distance X in meters (m) and the spring constant k in newtons per meter (N/m). The spring constant may vary as a function of temperature and as a function of time, as some materials may for instance loose stiffness under prolonged tensioning. However, above a certain load a material may be deformed to the extent its behavior is no longer in the linear elastic range.

In the context of the description and claims herein, the term “non-elastic” relates to a material having an elasticity of at most 5% elongation, at most 4% elongation, at most 3% elongation, or at most 2% elongation, or to a material which, when measured on a sample having a 22 mm width in the direction of elastic stretching and a 10 mm length, has a spring constant of at least 20.0 N/mm, at least 50.0 N/mm, at least 60.0 N/mm, at least 80.0 N/mm, at least 100.0 N/mm, at least 125.0 N/mm, at least 150.0 N/mm, at least 175.0 N/mm, or at least 200.0 N/mm

In the context of the description and claims herein, the term “elastic” relates to a material having an elasticity of at least 5% elongation, at least 8% elongation, at least 10% elongation, at least 20% elongation, at least 30% elongation, at least 40% elongation, or at least 50% elongation, or to a material which, when measured on a sample having a 22 mm width in the direction of elastic stretching and a 10 mm length, has a spring constant of at most 10.0 N/mm, at most 8.0 N/mm, at most 5.0 N/mm, at most 3.0 N/mm, at most 1.0 N/mm, at most 0.8 N/mm, at most 0.5 N/mm, at most 0.2 N/mm, or at most 0.1 N/mm

In the context of the description and claims herein, the term “X % elongation” relates to a percentage of elongation of the material resulting from strain in the elastic range of the material.

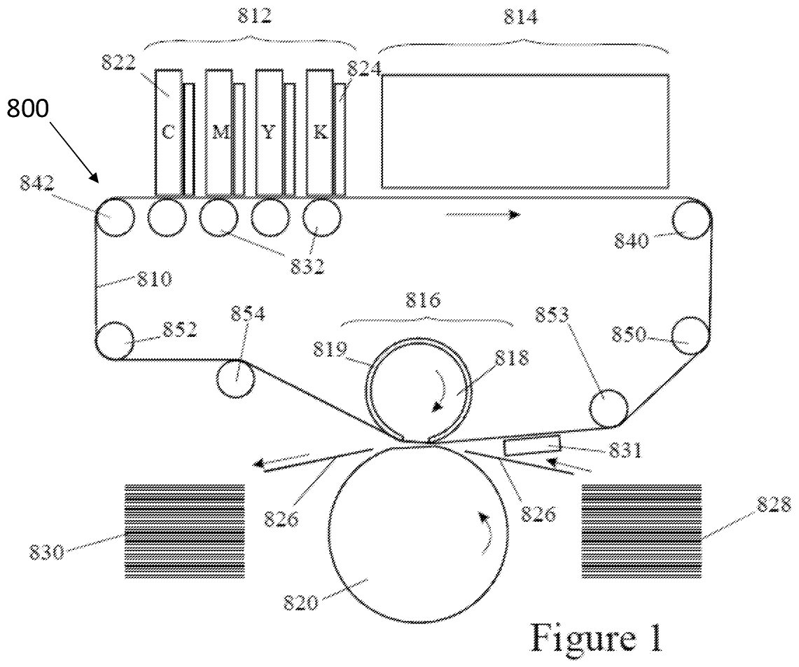

Reference is now made to FIG. 1, which is a schematic representation of a printing system of the invention. The printing system 800 of FIG. 1 comprises an ITM formed of an endless belt 810 that cycles through an image forming station 812, a drying station 814, and an impression station 816.

In the image forming station 812 four separate print bars 822 incorporating one or more print heads, that use inkjet technology, deposit aqueous ink droplets of different colors onto the surface of the belt 810. Though the illustrated embodiment has four print bars each able to deposit one of the typical four different colors (namely Cyan (C), Magenta (M), Yellow (Y) and Black (K)), it is possible for the image forming station to have a different number of print bars and for the print bars to deposit different shades of the same color (e.g. various shades of grey including black) or for two print bars or more to deposit the same color (e.g. black). Following each print bar 822 in the image forming station, an intermediate drying system 824 is provided to blow hot gas (usually air) onto the surface of the belt 810 to dry the ink droplets at least partially, to leave a tacky film having the ability to adhere to the substrate when transferred thereonto in the impression station.

In the impression station 816, the belt 810 passes between an impression cylinder 820 and a pressure cylinder 818 that carries a compressible blanket 819. Sheets 826 of substrate are carried by a suitable transport mechanism (not shown in FIG. 1) from a supply stack 828 and passed through the nip between the impression cylinder 820 and the pressure cylinder 818. Within the nip, the surface of the belt 810 carrying the ink image, is pressed firmly by the blanket 819 on the pressure cylinder 818 against the substrate 826 so that the ink image is impressed onto the substrate and separated neatly from the surface of the belt. The substrate is then transported to an output stack 830.

Belt 810 typically includes multiple layers, one of which is a hydrophobic release layer, as described, for example, in WO 2013/132418, which is herein incorporated by reference in its entirety.

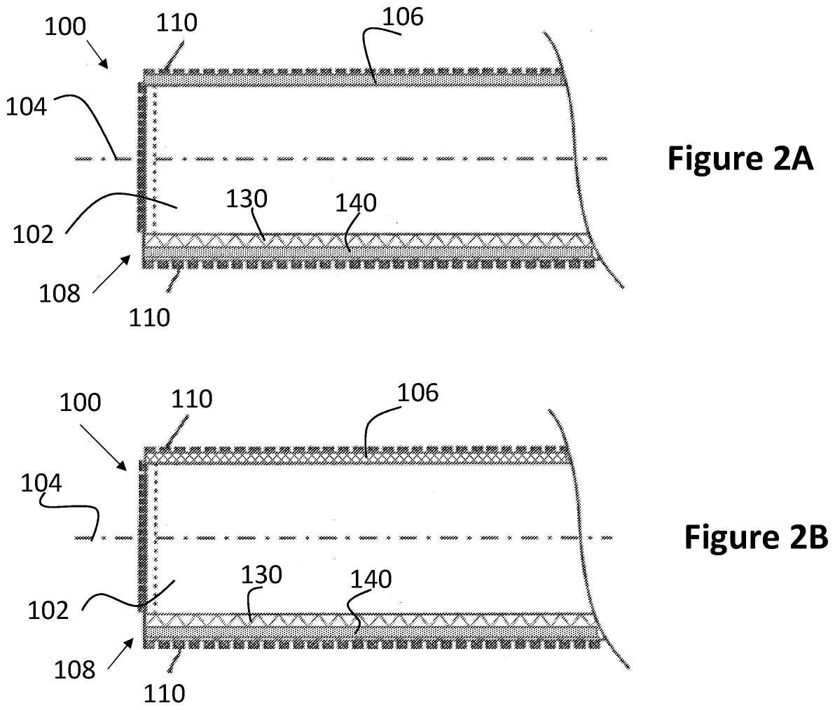

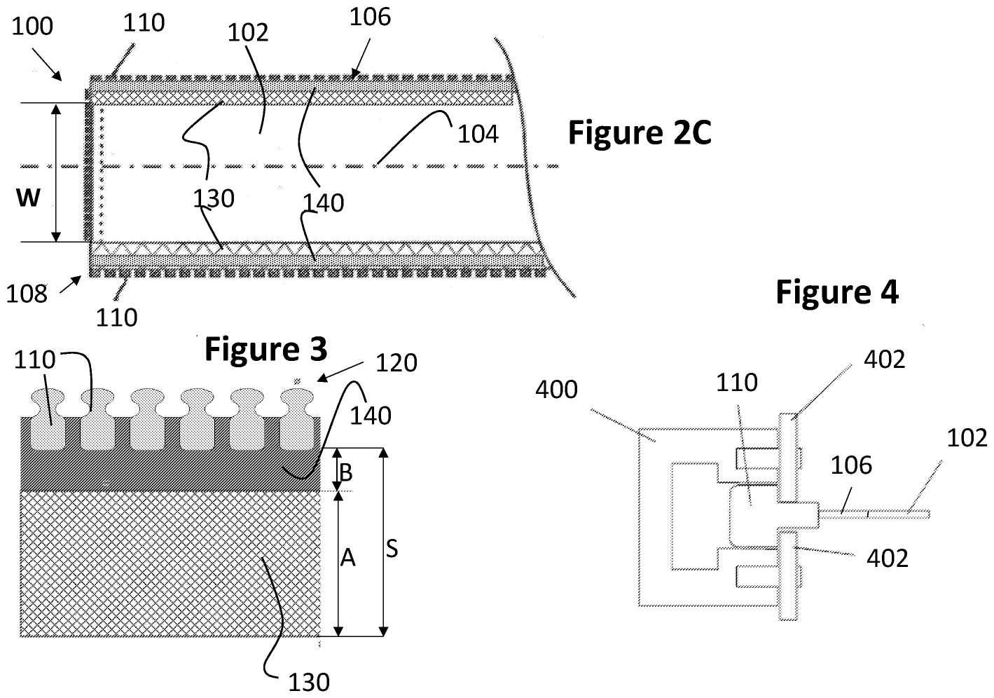

As explained in further detail hereinbelow with respect to FIGS. 2A to 4, the lateral edges of the belt 810 are provided with lateral formations which are received in a respective guide channel in order to maintain the belt taut in its width-ways dimension. As explained in detail hereinbelow, the formations 110 may be the teeth of one half of a zip fastener that is sewn or otherwise secured to the lateral edge of the belt, or may be a continuous flexible bead of greater thickness than the belt 810 may be provided along each side.

The method used for mounting the belt 810 within the guide channels is described in detail in U.S. Pat. Nos. 9,290,016, 9,643,403 and 9,517,618.

As described in U.S. Pat. Nos. 9,290,016, 9,643,403 and 9,517,618 which are hereby incorporated by reference in their entirety, it is important for the belt 810 to move with constant speed through the image forming station 812 as any hesitation or vibration will affect the registration of the ink droplets of different colors. To assist in guiding the belt smoothly, friction is reduced by passing the belt over rollers 832 adjacent each printing bar 822 instead of sliding the belt over stationary guide plates. Other guiding rollers of the system ensure that the belt is maintained in a desired orientation along the printing cycle.

It is possible for the belt 810 to be seamless, that is it to say without discontinuities anywhere along its length. However, the belt may be formed as an initially flat strip of which the opposite ends are secured to one another, for example by a zip fastener or possibly by a strip of hook and loop tape or possibly by soldering the edges together or possibly by using tape (e.g. Kapton® tape, RTV liquid adhesives or PTFE thermoplastic adhesives with a connective strip overlapping both edges of the strip), as described in the patents mentioned hereinabove.

Reference is now made to FIGS. 2A, 2B, and 2C, which are schematic plan view illustrations of three embodiments of a portion of an ITM according to embodiments of the teachings herein.

As seen in FIGS. 2A to 2C, an ITM 100, suitable for use in a printing system such as the printing system 800 of FIG. 1, includes an endless flexible belt 102 having a uniform belt width and formed of an elongate belt having a longitudinal axis 104.

Attached to lateral edges of endless flexible belt 102, and arranged along longitudinal axis 104, are a first elongate strip 106 and a second elongate strip 108, each including lateral formations 110 disposed on outward facing lateral ends of the strip, distal to belt 102.

In accordance with the present invention, at least one of first elongate strip 106 and second elongate strip 108 is a strip 120 as shown in FIG. 3, which includes a first longitudinal portion 130 extending along the longitudinal axis and having a first elasticity, and a second longitudinal portion 140 extending along the longitudinal axis and having a second elasticity, such that the second elasticity is greater than the first elasticity.

As seen in FIGS. 2A to 2C, the first longitudinal portion 130 is attached to the lateral edge or edges of the belt 102, and the second longitudinal portion 140 extends between the first longitudinal portion 130 and the lateral formations 110.

In some embodiments, the second longitudinal portion 140 is elastic in a width-ways direction thereof, perpendicular to the longitudinal axis 104.

In some embodiments, the spring constant representing the first elasticity of first longitudinal portion 130 is at least 10.0, at least 20.0, at least 30.0, at least 40.0, at least 50.0, at least 75.0, at least 100.0, at least 125.0, at least 150.0, at least 175.0, or at least 200.0 N/mm, when measured on a sample having a length of 10 mm and a width of 22 mm in the elastic direction. In some embodiments, the spring constant representing the first elasticity of first longitudinal portion 130 is in the range of 30.0 to 80.0 N/mm, when measured on a sample having a length of 10 mm and a width of 22 mm in the elastic direction.

In some embodiments, the first elasticity of first longitudinal portion 130 is at most 5% elongation, at most 4% elongation, at most 3% elongation, at most 2% elongation, at most 1% elongation, at most 0.5% elongation, at most 0.2% elongation, or at most 0.1% elongation.

In some embodiments, the spring constant representing the second elasticity of second longitudinal portion 140 is in the range of 0.1 to 10.0 N/mm, 0.1 to 8.0 N/mm, or 0.1 to 5.0 N/mm, 1.0 to 5.0 N/mm, 2.0 to 5.0 N/mm, or 3.0 to 5.0 N/mm when measured on a sample having a length of 10 mm and a width of 22 mm in the elastic direction. In some embodiments, the second elasticity of second longitudinal portion 140 is at least 5% elongation, at least 8% elongation, at least 10% elongation, at least 20% elongation, at least 30% elongation, at least 40% elongation, or at least 50% elongation.

In some embodiments, a ratio between spring constant measurements of the second elasticity of second portion 140 and the first elasticity of first portion 130, when measured in N/mm on a sample having a sample width of 22 mm and a sample length of 10 mm, is at least 1:4, at least 1:6, at least 1:10, at least 1:12, at least 1:20, at least 1:30, at least 1:40, at least 1:50, at least 1:60, at least 1:70, at least 1:80, at least 1:90, or at least 1:100. In some embodiments, the spring constant ratio is in the range of 1:6 to 1:25.

In some embodiments, the first longitudinal portion 130 is non-elastic, and the second longitudinal portion 140 is elastic.

As seen in FIG. 3, the first longitudinal portion has a first portion width, indicated by the letter A, the second longitudinal portion has a second portion width, indicated by the letter B, and the strip has a strip width indicated by the letter S.

In some embodiments, the first portion width A is in the range of 30% to 90% of the strip width S. In some embodiments, a ratio between the first portion width A and the strip width S is in the range of 1:1.1 to 1:3.

In some embodiments, the second portion width B is in the range of 10% to 90% of the strip width S. In some embodiments, a ratio between the second portion width B and the strip width S is in the range of 1:1.1 to 1:10.

In some embodiments, the first portion width A is in the range of 15 mm to 30 mm. In some embodiments, the first portion width A is in the range of 15 mm to 20 mm

In some embodiments, the second portion width B is in the range of 2 mm to 30 mm. In some embodiments, the second portion width B is in the range of 3 mm to 7 mm

In some embodiments, a ratio between the second portion width B and the first portion width A is in the range of 1:1 to 1:15.

As shown in FIG. 2A, the belt 102 has a belt width indicated by the letter W. In some embodiments, a ratio between the strip width S and the belt width W is in the range of 1:25 to 1:47. In some embodiments, a ratio between the first portion width A and the belt width W is in the range of 1:33.3 to 1:93.3. In some embodiments, a ratio between the second portion width B and the belt width W is in the range of 1:66.6 to 1:700.

In some embodiments, the strip width S is in the range of 20 mm to 40 mm. In some embodiments, the strip width S is in the range of 25 mm to 32 mm. In some embodiments, the belt width W is in the range of 1000 mm to 1400 mm

In some embodiments, illustrated for example in FIG. 2A, the first elongate strip 106 is an elastic strip, and the second elongate strip 108 is a strip 120 as illustrated in FIG. 3.

In some embodiments, illustrated for example in FIG. 2B, the first elongate strip 106 is a non-elastic strip, and the second elongate strip 108 is a strip 120 as illustrated in FIG. 3.

In some embodiments, illustrated for example in FIG. 2C, both the first elongate strip 106 and the second elongate strip 108 are elongate strips 120 as illustrated in FIG. 3.

The ITMs of FIGS. 2A, 2B, and 2C, are formed by obtaining the elongate flexible belt 102 and the elongate strips 106 and 108, and connecting the elongate strips to opposite lateral ends of belt 102. The connection may be by any suitable connection means, including sewing, adhering, fastening, laminating, and the like.

In some embodiments, the lateral formations 110 may be longitudinally spaced formations or projections, such as the teeth of one half of a ZIP fastener, as illustrated in FIG. 3.

Alternatively, the lateral formations 110 may be a continuous flexible bead disposed on each of the outward facing lateral ends of the first and second elongate strips 106 and 108.

The elongate strips 106 and 108 are secured to belt 102 such that there is substantially no elasticity between the coupling of the elongate strips 106 and 108 to the belt. For example, the strips 106 and 108 may be sewn or otherwise directly attached to the edge of the blanket or a substantially inelastic coupling member may be used to couple the strips to the side of the belt 102. This ensures that the lateral position of the blanket does not vary with respect to the position of the image forming station, and any required change in the width of the ITM is obtained by stretching of the elastic second portion(s) 140 of elongate strip 106 and/or elongate strip 108.

The elasticity of the second portion 130 is sufficient to maintain the belt taut when the lateral formations 110 are guided through their respective guide channels 880 (FIG. 4). The elasticity of the second portion 140 allows the distance of the lateral formations 110 attached thereto to vary from the notional centerline of the belt 102 to allow the belt to be maintained under lateral tension as the belt surface moves relative to the image forming station. By maintaining the belt under lateral tension this minimizes the risk of undulations forming in the surface of the intermediate transfer medium, thereby allowing for an image to be correctly formed by the image forming station on the surface of the intermediate transfer medium.

The reduced elasticity of the first portion 130 of elongate strip 120, which is the portion of the strip connected to belt 102, results in a separation between lateral formations 110 and the belt 102. As such, when forces are applied to the lateral formations 110, these forces are absorbed by elastic second portion 140 of the elongate strip, and are dampened by the less elastic, or preferably non-elastic, first portion 130, such that the forces have little or no impact on the belt 102 or on the connection of the belt 102 to the strip 120. As such, for example, stretching of the second portion 140 to accommodate changes in the distance between the tracks guiding the lateral formations does not cause any warping or shifting of the belt 102, since such stretching stops at first portion 130.

By contrast, in the prior art, when a fully elastic strip with lateral formations is used, application of force to the strip may result also in motion of the belt due to some of the force being applied to the belt. As such, the strip 120 of the present invention reduces motion of the belt in the width-ways direction thereof, reduces warping and/or undulations forming at the edges of the belt, improves the stability of the belt, and consequently improves the registration of printing.

Additionally, as shown hereinbelow in Example 2, the maximal load at a time of failure of the connection between an elongate strip 120 and the belt 102 is significantly higher than that required to cause a failure of the connection between a fully elastic strip and the belt 102. Without wishing to be bound by theory, the Inventors believe that when using a fully elastic strip, and due to the elasticity of the strip, some of the force applied to stretching the strip is also applied to the seam or fasteners connecting the strip to the belt, thus the fact that less elastic or non-elastic portion 130 is connected to the belt 102, and the elastic portion is not directly connected to the belt, results in the force being applied to the elastic portion 140 being applied to stretching the non-elastic portion 130, and as such does not pull the strip 120 away from the belt 102.

In some embodiments, the maximal load applied to a strip 120 connected to belt 102 at a time of failure between the strip 120 and the belt 102 is at least 50 N/mm

In some embodiments, the spring constant of the strip 120, and specifically of the second elastic portion 140 thereof, is stable under tension, and when being used and heated in a printing system, under normal printing conditions. In some such embodiments, the

Reference is now made to FIG. 4, which is a section through a guide channel for the ITM 100 (or belt 810 of FIG. 1) within which the lateral formations 110 shown in FIG. 3 are received.

As seen, the lateral formations 110, disposed on strips 106 and/or 108 connected to belt 102 of ITM 100, are received in a respective guide channel 400 in order to maintain the belt taut in its width-ways dimension. The guide channels 400 and may include rolling bearing elements 402 to retain the formations 110 therewithin.

Typically, when placing the belt in the guide channels of the printing system, the lateral formations 110 on strips 106 and 108 are at substantially the same distance from a notional centerline of the belt. However, in some cases, or in some parts of the guide channel, the elastic portion 140 may be stretched more on one side of the belt than on the other side, such that the lateral formations 110 on one side of the belt are at a greater distance from the nominal centerline of the belt than the formations 110 on the other side of the belt.

The lateral formations 110 need not be the same on both lateral edges of the belt 810 or 102. They can differ in shape, spacing, composition and physical properties, as described in WO 2013/136220, the contents of which are incorporated herein by reference.

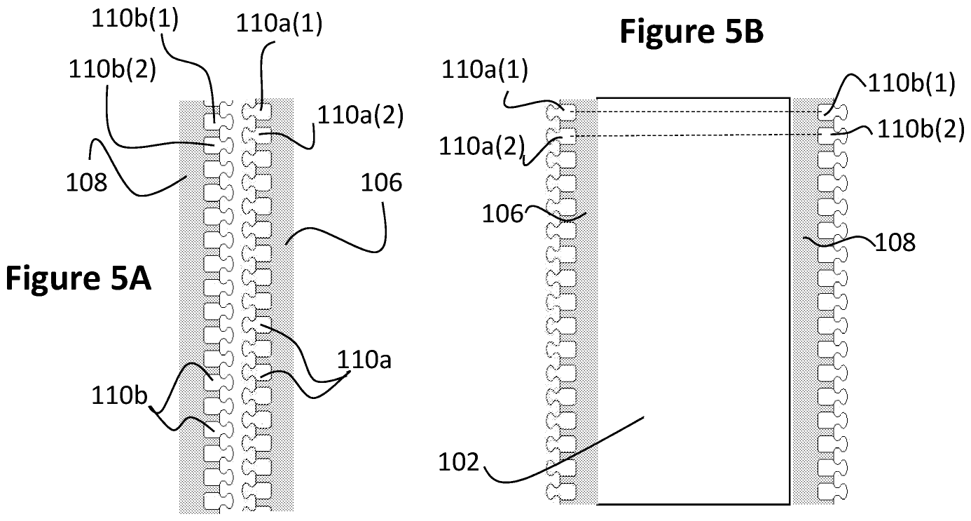

FIGS. 5A and 5B are schematic illustrations of corresponding elongate strips for both sides of the ITM, such as first and second elongate strips 106 and 108 of FIG. 2A at the time of manufacturing and when attached to a flexible belt, such as belt 102 of FIG. 2A, respectively.

As seen in FIG. 5A, the two corresponding elongate strips 106 and 108 are manufactured as two portions of a single zip fastener, which can attach to one another as in any standard zip fastener. As such, during manufacturing, the lateral formations 110a of elongate strip 106 are positioned corresponding to the gaps between the lateral formations 110b of elongate strip 108, and vice versa. Specifically, during manufacturing of the elongate strips, a first lateral formation 110a(1) of strip 106 is disposed above a first lateral formation 110b(1) of strip 108, which in turn is disposed above a second lateral formation 110a(2) of strip 106, beneath which is disposed a second lateral formation 110b(2) of strip 108. Such manufacturing of the two corresponding elongate strips 106 and 108 ensures that the elastic portions of the elongate strips are not stretched during manufacturing, thus preventing warping, curving, or undulation of the elastic portion of the strips once the lateral formations are in place. Additionally, such manufacturing of the strips ensures that the number of lateral formation, and their distribution along the strip, is identical in both sides of the belt.

Turning to FIG. 5B, it is seen that when the elongate strips 106 and 108 are attached to the flexible belt 102, the lateral formations 110a of elongate strip 106 and the lateral formations 110b of elongate strip 108 are aligned with one another, such that first lateral formation 110a(1) is at the same height as first lateral formation 110b(1), second lateral formation 110a(2) is at the same height as second lateral formation 110b(2), and so on.

### EXAMPLES

Reference is now made to the following examples, which together with the above description, illustrate the invention in a non-limiting fashion.

### Example 1

### Analysis of Spring Constant Measurement

A strip according to the present invention as illustrated in FIG. 3, including a first portion having a first elasticity, a second portion having a second elasticity, and lateral formations, was created. The strip had a strip width S of 28.5±1 mm, a first longitudinal portion width A of 18.5±1 mm, and a second longitudinal portion width B of 10 mm

A sample was taken from the strip, the sample having a width of 22 mm in the longitudinal direction of the strip, and was the entire width W of the strip.

The sample was placed in a Lloyd LS5 material tester, commercially available from Ametek® Inc. of Brewyn, Pa., USA using as the first grip a TG34 grip and as the second grip a portion of a guide channel taken from a printing system as described hereinabove, and a load cell of 1 kN. The TG34 grip held the second elongate portion of the sample at a distance of 10 mm from the lateral formations, and the guide channel grip held the teeth, or lateral formations, of the sample.

The tester was activated with a preload of 0.1N and with a preload stress of 10 mm/min, and was set to an extension cyclic test only. The extension rate during the test was set to 10 mm/min, and the test was repeated for 10 cycles of extending the sample and releasing it.

The spring constant of the sample was measured to be 3.0±0.5 N/mm During the test, the sample had a maximal elongation of 3 mm, or 30% elongation.

### Example 2

### Comparative Analysis of Failure

A first elongate strip (#1), as described hereinabove in Example 1, and a second fully elastic elongate strip (#2) having a uniform spring constant of 3.0±0.5 N/mm and lateral formations as for strip #1 were obtained. Each of the strips was adhered to an elongate flexible belt as described in PCT Application No. PCT/IB2017/053167 which is incorporated herein by reference in its entirety, by RTV734 flowable sealant commercially available from Dow Corning® of Midland, Mich., USA.

Samples were taken from each of the belts and strips, where each sample has a length of 22 mm along the longitudinal axis of the belt, and has a width of 200 mm

Each sample was placed in a Lloyd LS5 material tester, commercially available from Ametek® Inc. of Brewyn, Pa., USA using as the first grip a chantillon grip and as the second grip a portion of a guide channel taken from a printing system as described hereinabove, and a load cell of 1 kN. The chantillon grip held the belt of the sample, and the guide channel grip held the teeth, or lateral formations, of the sample. The sample was pulled up at room temperature, until there was a failure adhesion between the belt and the strip, or until the fabric of the strip tore.

Table 1 summarizes the load used when a failure occurred (in N/mm), and the type of failure.

TABLE 1

| Sample | Maximal load [N/mm] | Failure type |
|---|---|---|
| #1 | 120 | Adhesion |
| #2 | 50 | Adhesion |

An adhesion failure occurs when the strip including the lateral formations disconnects from the belt.

As seen in Table 1, sample #1 which includes, as the elongate strip, the inventive strip described herein, was able to resist a significantly greater load than Sample #2 which includes an elastic elongate strip, as described in the prior art.

The above description is simplified and provided only for the purpose of enabling an understanding of the present invention. For a successful printing system, the physical and chemical properties of the inks, the chemical composition and possible treatment of the release surface of the belt and the control of the various stations of the printing system are all important but need not be considered in detail in the present context.

It is appreciated that an ITM as described herein, together with a suitable guiding system, may be used to form in any indirect printing system employing an ITM, as the invention herein provides a novel mechanical structure of the ITM, but does not affect the chemical properties of the ITM, or any printing-process related characteristics thereof.

The contents of all of the above mentioned applications of the Applicant are incorporated by reference as if fully set forth herein.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

In the description and claims of the present disclosure, each of the verbs, “comprise” “include” and “have”, and conjugates thereof, are used to indicate that the object or objects of the verb are not necessarily a complete listing of members, components, elements or parts of the subject or subjects of the verb. As used herein, the singular form “a”, “an” and “the” include plural references unless the context clearly dictates otherwise. For example, the term “a formation” or “at least one formation” may include a plurality of formations.

1. An intermediate transfer member (ITM) for use in a printing system to transport ink images from an image forming station to an impression station for transfer of the ink image from the ITM onto a printing substrate, wherein the ITM comprises:
an endless flexible belt having a uniform belt width, said endless flexible belt formed of an elongate belt having a longitudinal axis;
a first elongate strip and a second elongate strip, said first and second elongate strips attached to lateral edges of said belt along said longitudinal axis, said first and second elongate strips each including lateral formations on outward facing lateral ends thereof, said outward facing lateral ends being distal to said lateral edges of said belt,
wherein, during use, said belt is configured to be guided by a guiding system through at least the image forming station, said guiding system comprising guide channels configured to receive said lateral formations,
wherein at least one of said first and second elongate strips has a strip width and includes a first longitudinal portion extending along said longitudinal axis and having first portion width and a first elasticity, and a second longitudinal portion extending along said longitudinal axis and having a second portion width and a second elasticity, said first portion being attached to said lateral edges of said belt and said second portion extending between said first portion and said lateral formations,
wherein said second elasticity is greater than said first elasticity.

2. The ITM of claim 1, wherein said lateral formations are configured to engage said guide channels, so that said belt is placed under tension in a width-ways direction perpendicular to said longitudinal axis, and is constrained to follow a continuous path defined by said guide channels.

3. The ITM of claim 1, wherein said second portion is elastic in a width-ways direction perpendicular to said longitudinal axis.

4. The ITM of claim 1, wherein said first longitudinal portion is non-elastic, and said second longitudinal portion is elastic.

5. The ITM of claim 1, wherein only said first elongate strip includes said first portion and said second portion, and wherein said second elongate strip is non-elastic.

6. The ITM of claim 1, wherein said first elongate strip and said second elongate strip each include a said first portion and a said second portion.

7. The ITM of claim 1, wherein an elasticity of said second portion of said first elongate strip is sufficient to maintain said belt taut when said lateral formations are guided through their respective guide channels.

8. The ITM of claim 1, wherein a ratio between said second portion width and said first portion width is in the range of 1:1 to 1:15.

9. The ITM of claim 1, wherein said strip width is in the range of 20 mm to 40 mm.

10. The ITM of claim 1, wherein said first elasticity is at least 10.0, at least 20.0, at least 30.0, at least 40.0, at least 50.0 N/mm, at least 75.0, at least 100.0, at least 125.0, at least 150.0, at least 175.0, or at least 200.0 N/mm.

11. The ITM of claim 1, wherein said first elasticity is at most 5% elongation, at most 4% elongation, at most 3% elongation, at most 2% elongation, at most 1% elongation, at most 0.5% elongation, at most 0.2% elongation, or at most 0.1% elongation.

12. The ITM of claim 1, wherein said second elasticity is in the range of 0.1 to 10.0 N/mm, 0.1 to 8.0 N/mm, 0.1 to 5.0 N/mm, 1.0 to 5.0 N/mm, 2.0 to 5.0 N/mm, or 3.0 to 5.0 N/mm.

13. The ITM of claim 1, wherein said second elasticity is at least 5% elongation, at least 8% elongation, at least 10% elongation, at least 20% elongation, at least 30% elongation, at least 40% elongation, or at least 50% elongation.

14. The ITM of claim 1, wherein a ratio between spring constant measurements of said second elasticity and said first elasticity, when measured in N/mm on a sample having a sample width of 22 mm and a sample length of 10 mm, is at least 1:4, at least 1:6, at least 1:10, at least 1:12, at least 1:20, at least 1:30, at least 1:40, at least 1:50, at least 1:60, at least 1:70, at least 1:80, at least 1:90, or at least 1:100.

15. A method of forming the ITM of claim 1, the method comprising: obtaining said elongate flexible belt;
obtaining said first elongate strip including said first and second longitudinal portions;
obtaining said second elongate strip; and
attaching said first and second elongate strips to said lateral edges of said elongate flexible belt.

16. (canceled)

17. A method of forming a flexible belt, the method comprising:
a. obtaining an elongate flexible belt having a uniform belt width and a longitudinal axis, said belt being suitable for use as an ITM in a printing system, said elongate flexible belt having first and second lateral edges;
b. obtaining a first elongate strip having a strip width and including:
a first longitudinal portion extending along said longitudinal axis and having a first portion width and a first elasticity, said first longitudinal portion extending along said first elongate strip at a first lateral end thereof;
lateral formations on a second lateral end of said first elongate strip; and
a second longitudinal portion extending along said longitudinal axis and having a second portion width and a second elasticity, said second longitudinal portion extending longitudinally between said first portion and said lateral formations,
wherein said second elasticity is greater than said first elasticity;
c. obtaining a second elongate strip having first and second lateral ends, and including lateral formations on said second lateral end thereof; and
d. attaching said second lateral ends of said first and second elongate strips to said first and second lateral edges of said elongate flexible belt.

18. A printing system comprising:
a. an intermediate transfer member (ITM) including:
(i) an endless flexible belt having a uniform belt width, said endless flexible belt formed of an elongate belt having a longitudinal axis;
(ii) a first elongate strip and a second elongate strip, each attached to lateral edges of said belt along said longitudinal axis, said first and second elongate strips each including lateral formations on outward facing lateral ends thereof, said outward facing lateral ends being distal to said lateral edges of said belt,
wherein at least one of said first and second elongate strips has a strip width and includes a first longitudinal portion having a first portion width and a first elasticity, and a second longitudinal portion having a second portion width and a second elasticity, said first portion being attached to said lateral edges of said belt and said second portion extending between said first portion and said lateral formations,
wherein said second elasticity is greater than said first elasticity;
b. an image forming station at which droplets of ink are applied to an outer surface of said ITM to form ink images thereon;
c. an impression station for transfer of the ink images from said ITM onto a printing substrate; and
d. a guiding system comprising guide channels configured to receive said lateral formations, said guiding system extending at least through said image forming station and configured, during use, to guide said ITM along said image forming station.

19. (canceled)

20. (canceled)

21. (canceled)

22. The printing system of claim 18, said second portion is elastic in a width-ways direction perpendicular to said longitudinal axis.

23. The printing system of claim 18, wherein said first longitudinal portion is non-elastic and said second longitudinal portion is elastic.

24. The printing system of claim 18, wherein only said first elongate strip includes said first portion and said second portion, and wherein said second elongate strip is non-elastic.

25. (canceled)

26. (canceled)

27. (canceled)

28. (canceled)

29. (canceled)

30. (canceled)

31. (canceled)

32. (canceled)

33. (canceled)
